(19) United States
(12) Patent Application Publication
(10) Pub. No.: US 2010/0251270 A1
(43) Pub. Date: Sep. 30, 2010

(54) Selective Mobile Metering

(75) Inventors: Gregory Dale, Leesburg, VA (US); Michael Brown, Ashburn, VA (US)

Correspondence Address: FISH & RICHARDSON P.C., P.O. BOX 1022, MINNEAPOLIS, MN, 55440-1022, US

(73) Assignee: comScore, Inc., Reston, VA (US)

(21) Appl. No.: 12/730,451

(22) Filed: Mar. 24, 2010

Related U.S. Application Data
(60) Provisional application No. 61/165,054, filed on Mar. 31, 2009.

(51) Int. Cl. G06F 15/16; G06F 9/46

(52) U.S. Cl. 719/328; 709/203

(57) ABSTRACT

A first list includes a first set of destination names. The first set of destination names including destination names involved in network communications engaged in by a device. A monitoring application is configured to access a second list that includes a second set of destination names, use the first list and the second list to access network communications, engaged in by the device, that involve the first set of destination names and the second set of destination names, collect information regarding the accessed network communications, and send the collected information to a server

### CROSS-REFERENCE TO RELATED APPLICATIONS

This application claims priority to U.S. Application No. 61/165,054, filed on Mar. 31, 2009, the contents of which are incorporated herein.

### BACKGROUND

Some operating systems provide a limited mechanism for third party application developers to access some or all of the network communications of the device on which the operating system is running. For instance, the operating system running on BlackBerry® devices currently provides a limited mechanism for third party application developers to access certain network communications of these devices.

### SUMMARY

In one aspect, a first list is stored on a client system that includes at least one processing device and a storage. The first list includes a first set of destination names. The first set of destination names includes destination names involved in network communications engaged in by the client system. A second list is accessed on the client system. The second list includes a second set of destination names. The first list and the second list are used on the client system to access network communications, engaged in by the client system, that involve the first set of destination names and the second set of destination names. Information regarding the accessed network communications is collected at the client system and sent to a server from the client system.

Implementations may include one or more of the following features. An application configured to engage in network communications involving destination names may be executed on the client system and the destination names involved in network communications engaged in by the client system may include destination names involved in the network communications engaged in by the application. The application may be a browser.

The first list may be an event log in which messages regarding activities of applications or system processes running on the client system are recorded. An application programming interface may be executed on the client system. The application programming interface may be configured to allow an application to register destination names and to provide access to network communications involving the registered destination names. Using the first list and the second list to access network communications, engaged in by the client system, that involve the first set of destination names and the second set of destination names may include accessing the first set of destination names included in the first list, registering the accessed first set of destination names with the application programming interface such that the application programming interface provides access to network communications involving the first set of destination names, accessing the second set of destination names included in the second list; and registering the second set of destination names with the application programming interface such that the application programming interface provides access to network communications involving the second set of destination names. The application programming interface may be configured to route requests for resources involving the registered first set of destination names and the registered second set of destination names to an application that registered the first set of destination names and the second set of destination names. The client system may be configured such that third-party applications can not access network communications engaged in by the client system except by registering destination names with the application programming interface.

The accessed network communications may include HTTP communications. The collected information regarding the accessed network communications may include a URL of a requested resource, an HTTP response code, an HTTP headers, or an HTTP response body. Accessing the second list may include downloading the second list from a configuration server. The destination names in the first set or the second set may include one or more of a domain name, a fully qualified domain name, a host name, a partial URL or a full URL.

In another aspect, a computer readable storage medium storing instructions that, when executed by one or more processing devices, cause the one or more processing devices to implement a first list and a monitoring application. The first list includes a first set of destination names and the first set of destination names include destination names involved in network communications engaged in by a device. The monitoring application is configured to access a second list that includes a second set of destination names, use the first list and the second list to access network communications, engaged in by the device, that involve the first set of destination names and the second set of destination names, collect information regarding the accessed network communications, and send the collected information to a server Implementations may include one or more of the following features. The instructions may include instructions that, when executed by the one or more processing devices, cause the one or more processing devices to implement an application. The application may be configured to engage in network communications involving destination names. The destination names involved in network communications engaged in by the device may include destination names involved in the network communications engaged in by the application. The application may be a browser.

The first list may be an event log in which messages regarding activities of applications or system processes running on the device are recorded.

The instructions may include instructions that, when executed by the one or more processing devices, cause the one or more processing devices to implement an application programming interface configured to allow an application to register destination names and to provide access to network communications involving the registered destination names. To use the first list and the second list to access network communications, engaged in by the device, that involve the first set of destination names and the second set of destination names, the monitoring application may be configured to, access the first set of destination names included in the first list, register the accessed first set of destination names with the application programming interface such that the application programming interface provides the monitoring application with access to network communications involving the first set of destination names, access the second set of destination names included in the second list, and register the second set of destination names with the application programming interface such that the application programming interface provides the monitoring application with access to network communications involving the second set of destination names. To provide the monitoring application with access to network communications involving the registered first set of destination names and the registered second set of destination names, the application programming interface may be configured to route requests for resources involving the registered first set of destination names and the registered second set of destination names to the monitoring application. The monitoring application may not be able to access network communications engaged in by the device except by registering destination names with the application programming interface.

The accessed network communications may include HTTP communications. The collected information regarding the accessed network communications may include a URL of a requested resource, an HTTP response code, an HTTP headers, or an HTTP response body. To access the second list, the monitoring application is further configured to download the second list from a configuration server. The destination names in the first set or the second set may include one or more of a domain name, a fully qualified domain name, a host name, a partial URL or a full URL.

In another aspect, a device includes one or more processing devices and a storage medium storing instructions that, when executed by the one or more processing devices, cause the one or more processing devices to implement a browser, an event log, an application programming interface, and a panel application. The browser is configured to send requests for resources and to receive responses to the requests. The resources have corresponding URLs, and the URLs include destination names. The event log is configured to record URLs corresponding to resources requested by the browser. The application programming interface is configured to allow an application to register destination names to access requests sent by the browser for resources with corresponding URLs that include the registered destination names or responses to the requests sent by the browser for resources with corresponding URLs that include the registered destination names. The panel application is configured to access a list of destination names, register the destination names on the accessed list with the application programming interface such that the panel application has access to requests sent by the browser for resources with corresponding URLs that include the destination names on the accessed list or responses to the requests sent by the browser for resources with corresponding URLs that include the destination names on the accessed list, in response to registering the destination names on the downloaded list with the application programming interface, access requests sent by the browser for resources with corresponding URLs that include the destination names on the accessed list or responses to the requests sent by the browser for resources with corresponding URLs that include the destination names on the downloaded list, send information regarding the accessed requests or the accessed responses to a collection server, access the event log and retrieve one or more URLs from the event log, wherein the retrieved URLs include destination names, register at least one of the destination names in the retrieved URLs with the application programming interface, and in response to registering the at least one destination name in the retrieved URLs with the application programming interface, access requests sent by the browser for resources with corresponding URLs that include the at least one destination name in the retrieved URLs or responses to the requests sent by the browser for resources with corresponding URLs that include the at least one destination name in the retrieved URLs.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1 illustrates a system in which a panel of computer users transmit data to a collection server.

FIG. 2 illustrates an example of a system that generally provides for the collection and analysis of data regarding the use of web resources by, for example, a panel of computer users.

FIG. 3 illustrates an excerpt of an example of a Blackberry® operating system event log.

FIG. 4 illustrates an excerpt of an example of an XML file in which information about HTTP traffic of a client system.

### DETAILED DESCRIPTION

Remote and local information regarding requested resources may be used by a client system in monitoring network communications engaged in by the client system. For example, in one implementation, a monitoring application on a client system retrieves, from a server, information associated with requested resources. The retrieved information includes destination names (for example, host names, fully qualified domain names, domain names, or Uniform Resource Locators (URLs)) corresponding to frequently requested resources (determined, for instance, based on a panel of client systems). The monitoring application also accesses information stored locally on the client system regarding resources requested by the client system. The accessed information includes destination names corresponding to resources requested by the client system. Using the retrieved and accessed information, the monitoring application collects information regarding network communications, engaged in by the client system, that involve the destination names included in the remote and local information, such as information regarding requests for web pages (or other resources) and/or subsequent responses to those requests. The monitoring application sends this collected information to a server, which can then process this information to determine analytics regarding usage related to the client system.

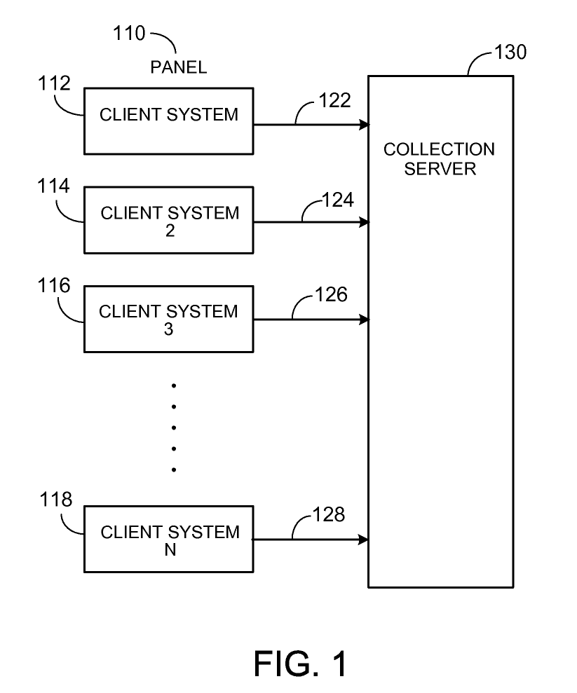

Referring to FIG. 1, a panel 110 includes client systems 112, 114, 116, and 118. The client systems 112, 114, 116, and 118 may be employed by users of these systems to access resources on a network, such as webpages or other resources on the Internet. Information about this resource access is sent by each client system 112, 114, 116, and 118 to a collection server 130. This information may be used to understand the usage habits of the users of the network.

The users of the client systems 112, 114, 116, and 118 may be a group of users that are representative of a larger group of users. For example, these users may be composed such that the panel reflects an average Internet user. In another example, these users may be composed of users belonging to one or more demographic groups of interest to providers of goods and services. The information sent to the collection server 130 may be used to extrapolate usage habits of the larger group of users, such as the total population of Internet users or total population of users in a particular demographic (or both).

Accordingly, for example, when users of the client systems 112, 114, 116, and 118 visit and view web pages (for example, while browsing the Internet using a browser application), information about these visits are sent to the collection server 130 and may later be analyzed to determine the visitation or other habits of the users, which may be extrapolated to the larger population of all Internet users.

In the example shown in FIG. 1, the panel 110 includes client systems 112, 114, 116, and 118. However, in other implementations, the panel 110 may be composed of more or fewer client systems. A monitoring application, also referred to as a panel application, is installed on each of the client systems 112, 114, 116, and 118. The panel application may collect information about requests for data made by the client systems 112, 114, 116, and 118 and responses received by the client systems 112, 114, 116, and 118 and may send that information to the collection server 130 for analysis regarding usage habits. Thus, each of the client systems 112, 114, 116, and 118 may send data 122, 124, 126, and 128, respectively, to the collection server 130 where the data 122, 124, 126, and 128 is stored and processed.

Similarly, in the example shown in FIG. 1, there is a single collection server 130. However, in other implementations there may be more than one collection server 130. For example, each of the client systems 112, 114, 116, and 118 may send data 122, 124, 126, and 128 to more than one collection server for redundancy. In other implementations, the client systems 112, 114, 116, and 118 may send data 122, 124, 126, and 128 to different collection servers. In this implementation, the data 122, 124, 126, and 128, which represents data from the entire panel, may be communicated to and aggregated at a central location for later processing. In this implementation, the central location may be one of the collection servers.

Generally, each of the client systems 112, 114, 116, and 118 and collection server 130 may be implemented using, for example, a general-purpose computer capable of responding to and executing instructions in a defined manner, a personal computer, a special-purpose computer, a workstation, a server, or a mobile device. Client systems 112, 114, 116, and 118 and collection server 130 may receive instructions from, for example, a software application, a program, a piece of code, a device, a computer, a computer system, or a combination thereof, which independently or collectively direct operations. The instructions may be embodied permanently or temporarily in any type of machine, component, equipment, storage medium that is capable of being used by a client system 112, 114, 116, and 118 and collection server 130.

In one implementation, the client systems 112, 114, 116, and 118 are composed of a mix of different mobile devices, with some of the mobile devices providing third party application developers with limited access to network communications, while some of the mobile devices provide the third party application developers with full or nearly full access to network communications. For example, in one implementation, the client systems 112, 114, 116, and 118 are composed of mobile devices running the Symbian® operating system, devices running the Palm® operating system, devices running the Windows Mobile® operating system, and devices running the Blackberry® operating system.

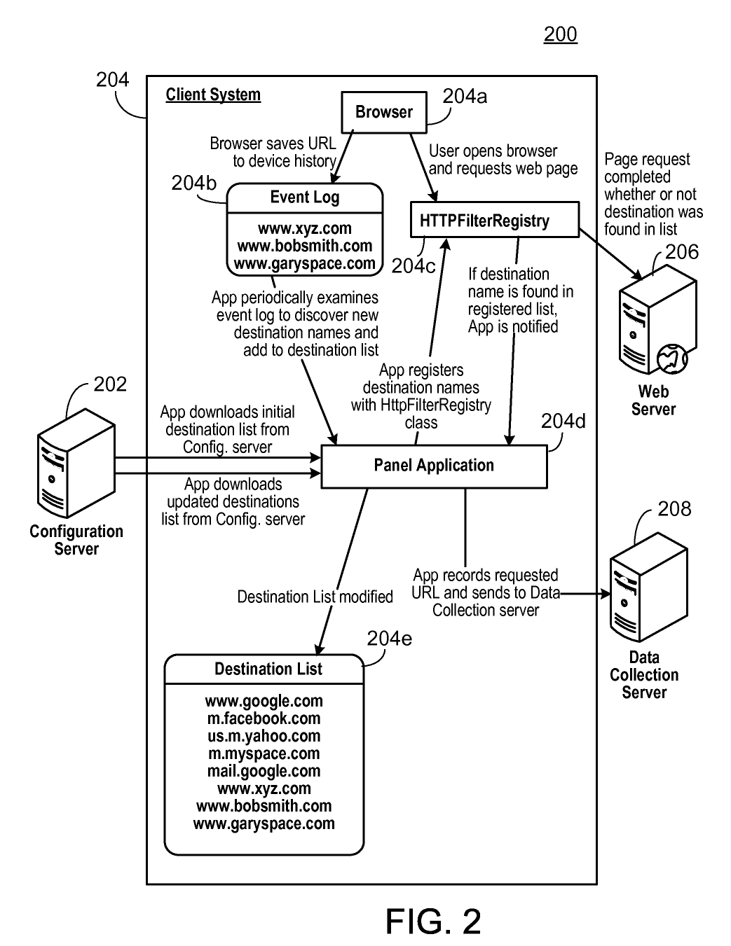

FIG. 2 illustrates an example of a system 200 that provides for the collection and analysis of data regarding the access of network resources by, for example, a panel of users that employ devices which provide third parties with limited access to network communications engaged in by the devices. The collection and analysis of this data may yield analytics regarding the habits of users viewing webpages or other network content.

The example shown in FIG. 2 is directed to an implementation in which a client system 204 is a mobile device running the Blackberry® operating system, which is produced by Research In Motion Limited, otherwise referred to as RIM®. Currently, the Blackberry® operating system provides third party application developers with limited access to network communications. In particular, the Blackberry® operating system does not allow a third party application to access all HyperText Transfer Protocol (HTTP) communications on the device. Rather, to access HTTP communications, the third party application has to register specific fully qualified domain names (for example, “myhost.example.com”) for which the application will act as a protocol handler. The names registered can not be wild carded. HTTP communications with respect to the registered fully qualified domain names will then be routed to the third party application, but HTTP communications with respect to other fully qualified domain names will not be routed to the third party application. The application programming interface (API) for registering a fully qualified domain names is referred to as HTTPFilterRegistry and is described, for instance, in Blackberry Java Development Environment Version 4.1.0, Blackberry Application Developer Guide, Volume 2: Advanced Topics, a copy of which is incorporated herein by reference.

Since the example shown in FIG. 2 is directed to an implementation in which a client system 204 is a mobile device running the Blackberry® operating system, the destination names referred to below are fully qualified domain names. However, in other implementations, an API may allow for the registration of other types of destination names in addition or as an alternative to fully qualified domain names. For instance, in other implementations, a destination name may be a domain name (for example, “example.com”), a host name (for example, “myhost”), a complete or partial URL (for example, myhost.example.com/index.html”), or other identifier or partial identifier of the destination of a communication.

The system 200 includes the client system 204, one or more web servers 206, one or more collection servers 208, and one or more configuration servers 202. The client system 204 is capable of communicating with the web server 206, the collection server 208, and the configuration server 202 over a network such as, for example, the Internet. The client system 204 can be one of a number of client systems in a panel, as described with respect to FIG. 1. In one implementation, there are multiple client systems like client system 204 in the panel, as well as other client systems running other operating systems that provide third party application developers with full or nearly full access to network communications.

The client system 204 retrieves resources, such as webpages, from the web server 206 using, for example, HTTP. The client system 204 also retrieves information from the configuration server using, for example, HTTP. Using the information from the configuration server 202 and locally stored information, the client system 204 collects information regarding network communications engaged in by the client system, such as information regarding the requests for web pages (or other resources) and/or subsequent responses to those requests. The client system 204 sends this collected information to the collection server 208 using, for example, HTTP. The collection server 208 stores data received from the client system 204, which can then be processed (with or without data from other client systems) to determine analytics regarding usage of such client systems.

More specifically, the client system 204 includes one or more processors and a storage medium storing instructions that, when executed by the one or more processing devices, cause the one or more processing devices to implement a browser application 204a, an event log 204b, an HTTPRegistryFilter API 204c, a panel application 204d, and a destination list 204e. The browser application 204a is used to request and displays web pages or other resources on the client system 204. For instance, the browser 204a may use HTTP to request and receive network resources (e.g., web pages) that have a corresponding Uniform Resource Locator (URL).

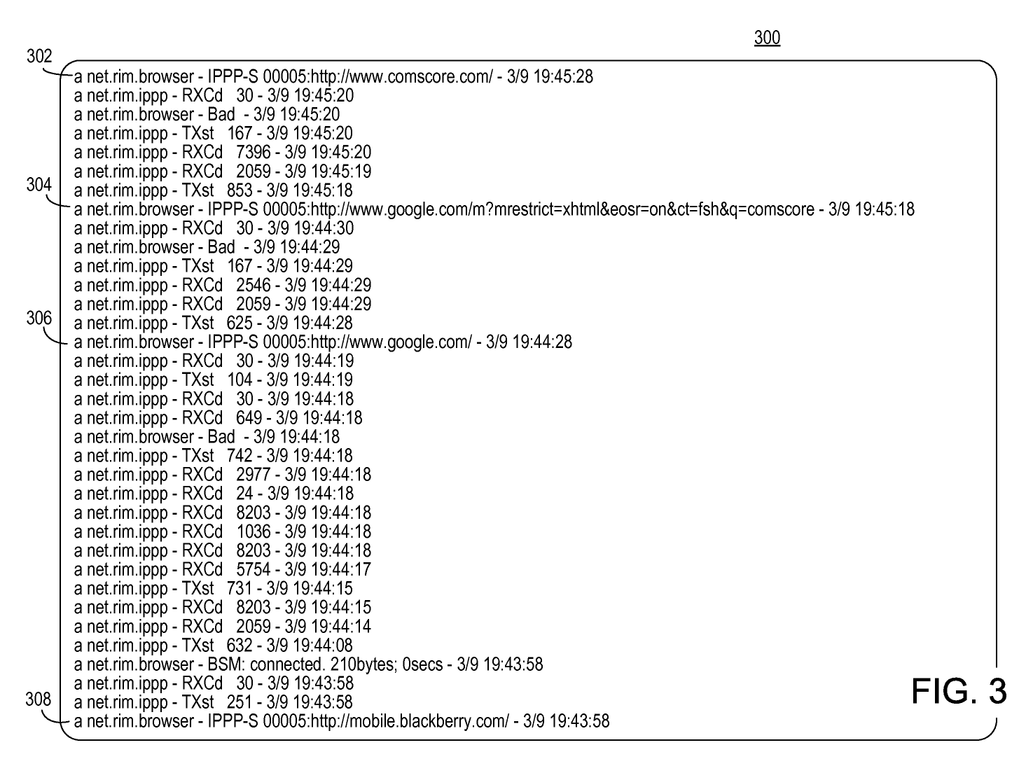

The event log 204b records the URLs corresponding to the resources requested by the browser 204a. In one implementation, the event log 204b is an event log provided by the Blackberry® operating system to capture various events that occur on the client system 204, such as error, warning, or other informational messages regarding activities by applications (e.g., the browser application) or system processes (e.g., the network stack). An excerpt of an example of such an event log is shown in FIG. 3. In another implementation, the event log is a browser history of the browser 204a.

The HTTPFilterRegistry API 204c provides a mechanism for third party applications to register as a handler for specific destination names. When resources with URLs corresponding to the registered destination names are requested using HTTP, e.g., by the browser 204a, the connection stack is re-routed to the third party application.

The panel application 204 may be an application that is downloaded to the client system 204 to perform the operations as described. In one implementation, the panel application is developed by a third party to perform monitoring of the usage of client systems.

The panel application 204d retrieves an initial destination list from the configuration server 202 and stores that initial destination list as a local destination list 204e. The initial destination list includes a list of destination names for which traffic is to be monitored. The initial destination list may be generated, for example, based on information sent to the collection server 208 by other devices in the panel that do not have limited access to HTTP. In this case, these devices may include a panel application that is able to access and report information to the collection server 208 on all or nearly all HTTP communications that occur on these devices. This information may be used to generate, for instance, a list of the top N destination names that are included in the URLs corresponding to the resources requested by that subset of the panel. This list can then be used to populate the destination list.

In another implementation, rather than the panel application 204d downloading the initial destination list, the panel application 204d may access an initial destination list that was installed on the client system 204 with the panel application 204d. This list, for example, may be encoded within the executable file for the panel application 204 or may be installed as a separate file that is read by the executable file for the panel application 204d.

The panel application 204d uses the downloaded or otherwise accessed initial destination list to access network communications involving the destination names on the downloaded list. For instance, the panel application 204d registers the destination names on the downloaded destination list with the HTTPFilterRegistry API 204c. When resources corresponding to URLs that do not include the registered destination names are requested, for example, by the browser 204a, the requests are passed normally through the network stack to the web server 206 and the responses to those requests are passed normally through the stack to the browser 204a. However, when resources corresponding to URLs with registered destination names are requested, for example, by the browser 204a, the requests are routed to the panel application 204d.

In one implementation, the panel application 204d handles the request. In particular, the panel application 204d retrieves the resource (e.g., web page) corresponding to the URL by sending a request to the web server 206 and receiving a corresponding response from the web server 206. The panel application 204d forwards the resource to the requesting application (e.g., the browser 204a).

In another implementation, the panel application 204d, rather than handling the request, returns a null to the browser 204a. This causes the browser 204a to make another request, which is routed normally through the network stack (rather than being directed to the panel application 204d).

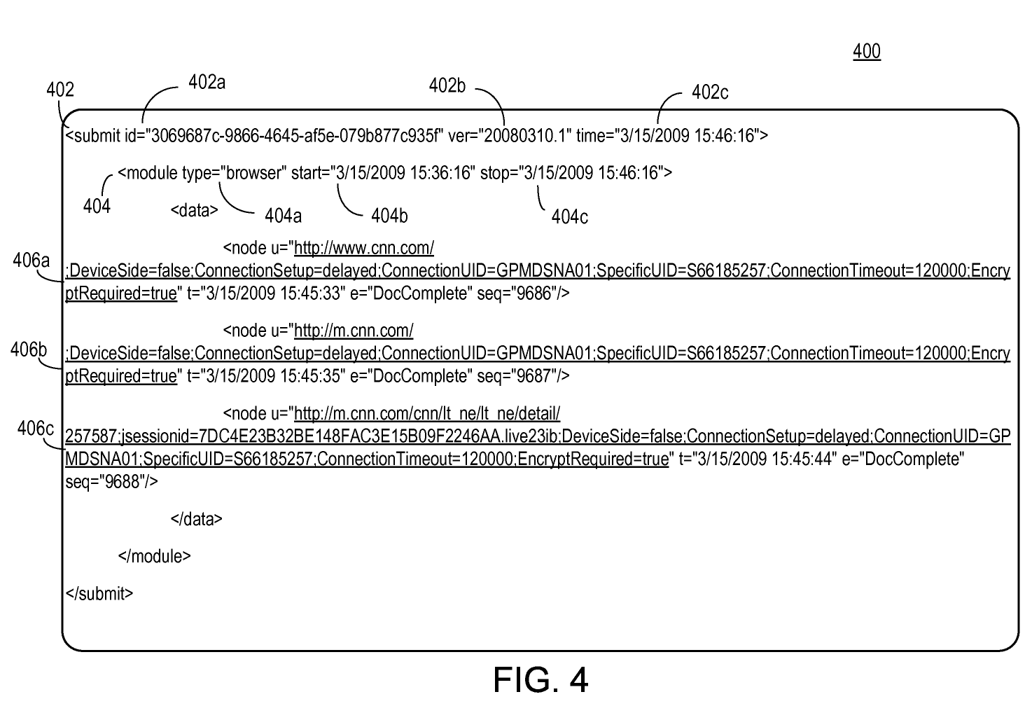

In addition, the panel application 204d collects information regarding the network communications involving the registered destination names from the downloaded list, including, for example, information regarding the requests and/or the subsequent responses for those requests routed to the panel application 204d. The panel application 208 sends the collected information to the collection server 208. This collected information 534 may include, for example, the URL requested and a time stamp of when the response was received, as well as other information such as HTTP response codes, HTTP headers, and information about the response body (e.g., an HTTP response body) and/or the request body (e.g., an HTTP request body). The panel application 204d may send this information to the collection server 208 as the requests and responses occur, or the panel application 204d may collect this information, and send the collected information to the collection server 208 on a periodic or other basis. For instance, the collected information may be collected at the client system 204 in an eXtensible Mark-up Language (XML) file, with the XML file being periodically transmitted to the collection server 208. An excerpt of an example of such an XML file is shown in FIG. 4. As described above, the collection server 208 receives such data from a number of client systems, and this data can be processed to determine analytics about the usage of the client systems.

The panel application 204d also may use the event log 204b to access network communications involving destination names included in the event log 204b. For example, the panel application 204d may periodically or aperiodically access the event log 204b and analyze the event log to determine the URLs corresponding to resources that have been requested during some previous period. The panel application 204d compares the destination names corresponding to the URLs retrieved from the event log 204b to the destination names on the local destination list 204e. Based on this comparison, the panel application 204d determines which destination names corresponding to the retrieved URLs are not already included on the destination list 204e. The panel application 204d then adds those destination names not already on the destination list 204e to the local destination list 204e and registers these new destination names with the HTTPFilterRegistry API 204c.

In one implementation in which the event log 204b is the device event log provided by the Blackberry(r) operating system, for example, the panel application 204d can access and analyze the event log for URLs by issuing a set of keystrokes (e.g., ALT+LGLG) to access the event log 204b, perform a keyword search to find events that correspond to HTTP activity, and then access the URLs corresponding to the resources requested during that HTTP activity.

By additionally registering the destination names requested on the client system 204, the destination names that are monitored for a given client system may be tailored based on the requests made using the client system. Using the downloaded destination list, and supplementing this downloaded destination list with destination names requested using the client system 204 may allow for a significant portion of or all of the HTTP traffic on the client system 204 to be monitored. For instance, if the client system 204 is a mobile device, then this device may not be used as extensively for web browsing as, for example, a desktop computer and, rather, the user may simply use this device to browse to just a few, favorite websites. Therefore, the list of destination names provided by the configuration server 202 may cover a significant percentage of the destination names that are likely to be requested using the client system 204, with the tailoring of the list on the client system 204 further increasing the percentage of destination names requested by the client system 204 that are monitored.

The panel application 204d also may periodically or aperidodically download an updated destination list from the configuration server 202. The destination list may be updated to take into account changes to the most highly requested destination names so as to help ensure that a significant portion of traffic is captured on client systems such as client system 204. If the client system 204 has limited storage, then some or all of the destination names that are no longer on the downloaded destination list may be removed from the local destination list 204e. To the extent that storage is not a concern, then the local destination list 204e can be supplemented with the destination names on the updated destination list downloaded from the configuration server 202 that are not already on the local destination list 204e.

FIG. 3 illustrates an excerpt 300 of an example of a Blackberry® operating system event log. Excerpt 300 includes several types of events. One type of these events is the “browser” event, which is designated as “a.net.rim.browser.” Some browser events are registered in the event log, for example, when the browser or other application is used to request a resource. Such a registered browser event includes the URL corresponding to the requested resource. For example, browser events 302, 304, 306, and 308 were registered when the resources corresponding to the URLs in each respective browser event 302, 304, 306, or 308 were requested. Thus, by searching the event log for “browser” events, and then analyzing the browser events to obtain included URLs, an application, such as panel application 204d, can determine a list of URLs requested by the client device. For instance, the panel application 204d may analyze the excerpt 300 and retrieve the URLs in the browser events 302, 304, 306, and 308.

FIG. 4 illustrates an excerpt 400 of an example of an XML file that contains information about HTTP traffic of a client system, such as client system 204. The XML file may be transmitted from the client system to a collection server, such as collection server 208.

The excerpt 400 includes a submit tag 402, which includes an id attribute 402a, a ver attribute 402b, and a time attribute 402c. The id attribute 402a designates an id number that identifies the client system. The ver attribute 402b designates a version number of the panel application. The time attribute 402c designates the time that this XML file was submitted to the collection server.

The excerpt 400 also includes a module tag 404, which includes a type attribute 404a, a start attribute 404b, and a stop attribute 404c. The type attribute 404a indicates the type of collected data. In this example, the value “browser” indicates that collected data is HTTP traffic of the client system. The start attribute 404b indicates the start time for this data collection period, and the stop attribute 404c indicates the stop time for this data collection period.

Multiple node tags 406a-406c are included in the excerpt 400. The node tags 406a-406c include information regarding the requests and/or responses. Each node tag includes a u attribute, at attribute, an e attribute, and a seq attribute. The e attribute designates a particular event, such as requesting a URL or receiving a response to such a request. For instance, in the example shown, the event “DocComplete” indicates that the response to a request for a resource was received, loaded, and initialized. Other events may indicate information such as (1) a resource has been requested, but not received yet, (2) a resource has been received, but not loaded and initialized yet, (3) an HTTP transaction is being submitted, (4) an HTTP transaction was canceled, (5) an HTTP transaction was closed, (6) an HTTP transaction is complete, (7) a transaction failed, (8) a transaction succeeded, (9) the HTTP headers have been received, but not the body, and/or (10) a request was redirected.

The u attribute designates the URL associated with a particular event and the t attribute designates the time the event occurred. Lastly, the seq attribute designates a sequence number of the particular node tag 406a, 406b, or 406c within the module tag 404.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components.

Accordingly, other implementations are within the scope of the following claims.

What is claimed is:

1. A method comprising:
storing, on a client system that includes at least one processing device and a storage, a first list that includes a first set of destination names, the first set of destination names including destination names involved in network communications engaged in by the client system;
accessing, on the client system, a second list that includes a second set of destination names;
using, on the client system, the first list and the second list to access network communications, engaged in by the client system, that involve the first set of destination names and the second set of destination names;
collecting, at the client system, information regarding the accessed network communications; and
sending the collected information to a server from the client system.

2. The method of claim 1 further comprising:
executing, on the client system, an application configured to engage in network communications involving destination names; and
wherein the destination names involved in network communications engaged in by the client system include destination names involved in the network communications engaged in by the application.

3. The method of claim 2 wherein the application is a browser.

4. The method of claim 1 wherein the first list is an event log in which messages regarding activities of applications or system processes running on the client system are recorded.

5. The method of claim 1 further comprising executing, on the client system, an application programming interface configured to allow an application to register destination names and to provide access to network communications involving the registered destination names.

6. The method of claim 5 wherein using, on the client system, the first list and the second list to access network communications, engaged in by the client system, that involve the first set of destination names and the second set of destination names comprises:
accessing the first set of destination names included in the first list;
registering the accessed first set of destination names with the application programming interface such that the application programming interface provides access to network communications involving the first set of destination names;
accessing the second set of destination names included in the second list; and
registering the second set of destination names with the application programming interface such that the application programming interface provides access to network communications involving the second set of destination names.

7. The method of claim 6 wherein, to provide access to network communications involving the registered first set of destination names and the registered second set of destination names, the application programming interface is configured to route requests for resources involving the registered first set of destination names and the registered second set of destination names to an application that registered the first set of destination names and the second set of destination names.

8. The method of claim 5 wherein the client system is configured such that third-party applications can not access network communications engaged in by the client system except by registering destination names with the application programming interface.

9. The method of claim 1 wherein the accessed network communications include HTTP communications.

10. The method of claim 1 wherein the collected information regarding the accessed network communications includes a URL of a requested resource, an HTTP response code, an HTTP headers, or an HTTP response body.

11. The method of claim 1 wherein accessing the second list comprises downloading the second list from a configuration server.

12. The device of claim 1 wherein the destination names in the first set or the second set include one or more of a domain name, a fully qualified domain name, a host name, a partial URL or a full URL.

13. A computer readable storage medium storing instructions that, when executed by one or more processing devices, cause the one or more processing devices to implement:
a first list that includes a first set of destination names, the first set of destination names including destination names involved in network communications engaged in by a device; and
a monitoring application configured to:
access a second list that includes a second set of destination names;
use the first list and the second list to access network communications, engaged in by the device, that involve the first set of destination names and the second set of destination names;
collect information regarding the accessed network communications; and
send the collected information to a server

14. The medium of claim 13 wherein the instructions further comprise instructions that, when executed by the one or more processing devices, cause the one or more processing devices to implement the following:
an application configured to engage in network communications involving destination names;
wherein the destination names involved in network communications engaged in by the device include destination names involved in the network communications engaged in by the application.

15. The medium of claim 14 wherein the application is a browser.

16. The medium of claim 13 wherein the first list is an event log in which messages regarding activities of applications or system processes running on the device are recorded.

17. The medium of claim 13 wherein the instructions further comprise instructions that, when executed by the one or more processing devices, cause the one or more processing devices to implement the following:
an application programming interface configured to allow an application to register destination names and to provide access to network communications involving the registered destination names.

18. The medium of claim 17 wherein, to use the first list and the second list to access network communications, engaged in by the device, that involve the first set of destination names and the second set of destination names, the monitoring application is further configured to:
access the first set of destination names included in the first list;
register the accessed first set of destination names with the application programming interface such that the application programming interface provides the monitoring application with access to network communications involving the first set of destination names;
access the second set of destination names included in the second list; and
register the second set of destination names with the application programming interface such that the application programming interface provides the monitoring application with access to network communications involving the second set of destination names.

19. The medium of claim 18 wherein, to provide the monitoring application with access to network communications involving the registered first set of destination names and the registered second set of destination names, the application programming interface is configured to route requests for resources involving the registered first set of destination names and the registered second set of destination names to the monitoring application.

20. The medium of claim 17 wherein the monitoring application can not access network communications engaged in by the device except by registering destination names with the application programming interface.

21. The medium of claim 13 wherein the accessed network communications include HTTP communications.

22. The medium of claim 13 wherein the collected information regarding the accessed network communications includes a URL of a requested resource, an HTTP response code, an HTTP headers, and or an HTTP response body.

23. The medium of claim 13 wherein, to access the second list, the monitoring application is further configured to download the second list from a configuration server.

24. A device comprising:
one or more processing devices;
a storage medium storing instructions that, when executed by the one or more processing devices, cause the one or more processing devices to implement the following:
a browser configured to send requests for resources, and to receive responses to the requests, wherein the resources have corresponding URLs, and the URLs include destination names;
an event log configured to record URLs corresponding to resources requested by the browser;
an application programming interface configured to allow an application to register destination names to access requests sent by the browser for resources with corresponding URLs that include the registered destination names or responses to the requests sent by the browser for resources with corresponding URLs that include the registered destination names;
a panel application configured to:
access a list of destination names;
register the destination names on the accessed list with the application programming interface such that the panel application has access to requests sent by the browser for resources with corresponding URLs that include the destination names on the accessed list or responses to the requests sent by the browser for resources with corresponding URLs that include the destination names on the accessed list;
in response to registering the destination names on the accessed list with the application programming interface, access requests sent by the browser for resources with corresponding URLs that include the destination names on the accessed list or responses to the requests sent by the browser for resources with corresponding URLs that include the destination names on the accessed list;
send information regarding the accessed requests or the accessed responses to a collection server;
access the event log and retrieve one or more URLs from the event log, wherein the retrieved URLs include destination names;
register at least one of the destination names in the retrieved URLs with the application programming interface;
in response to registering the at least one destination name in the retrieved URLs with the application programming interface, access requests sent by the browser for resources with corresponding URLs that include the at least one destination name in the retrieved URLs or responses to the requests sent by the browser for resources with corresponding URLs that include the at least one destination name in the retrieved URLs.
